(19) United States
(12) Patent Application Publication
(10) Pub. No.: US 2007/0266015 A1
(43) Pub. Date: Nov. 15, 2007

(54) User Created Search Vertical Control of User Interface

(75) Inventors: Darren A. Shakib, North Bend, WA (US); Gary W. Flake, Bellevue, WA (US); Ramez Naam, Seattle, WA (US); Randall F. Kern, Seattle, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: Microsoft Corporation, Redmond, WA (US)

(21) Appl. No.: 11/383,160

(22) Filed: May 12, 2006

(51) Int. Cl. G06F 17/30

(52) U.S. Cl. 707/4

(57) ABSTRACT

User-defined search vertical control over the presentation of search results in search results user interfaces is provided. Users may create and save search macros that are capable of modifying a search engine to perform searches and present results according to user specifications. A search macro defines both search operators for specifying search aspects and user interface operators for specifying features of the search results user interface. When entering a search query, a user may select a search macro. The search engine is modified based on the operators of the selected search macro, and search results are presented in a search results user interface in accordance with use interface operators defined by the selected search macro.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

A search engine is a program designed to find information stored on one or more computing devices. In its most recognized format, search engines, such as those employed by MSN, Yahoo, and Google, for example, are used to find websites and documents throughout the Internet. These types of search engines typically perform “horizontal” searches, providing a breadth of information related to the search query. However, users often desire information within a narrow topic or field. Accordingly, vertical search engines have been designed to perform specialized searches to mine data for a narrow niche. For example, a shopping vertical search engine may be employed to search information for products users may wish to purchase. Other types of verticals include image verticals, job/career verticals, travel verticals, local services verticals, research verticals, real estates verticals, automobile verticals, and news verticals, for example.

Typically, users turn to commercially-available vertical search engines to perform vertical searches. However, users may be dissatisfied with the choice of available vertical search engines. For example, there may not be a commercially-available vertical search engine directed to the specific topic with which users wish to search or the vertical search engines that are available may not be sufficiently tailored for users' purposes. In such cases, users may wish to create their own search verticals. Additionally, users may wish to control the way in which search results are presented in a search results user interface associated with search verticals they employ. However, the creation of a search vertical from top to bottom, including aspects of a search results user interface, requires sophisticated knowledge that typical users do not possess. Further, even for those users who are savvy enough to create their own search verticals, there currently is no convenient way for users to share personalized search verticals.

### BRIEF SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

User-defined control of user interfaces for presenting search results is described herein. Users may create and save search macros that are capable of modifying a search engine to perform searches and present results based on user-defined operators. Each macro includes a definition having one or more search operators that control search aspects and one or more user interface operators that control aspects regarding how search results are presented in a search results user interface. When a user enters a search query and selects a search macro, a search engine is modified based on operators defined by the selected search macro. Search results from the modified search engine are presented in a search results user interface in accordance with user interface operators of the selected search macro.

### BRIEF DESCRIPTION OF THE SEVERAL VIEWS OF THE DRAWING

The present invention is described in detail below with reference to the attached drawing figures, wherein:

FIG. 1 is a block diagram of an exemplary computing environment suitable for use in implementing embodiments of the present invention;

FIG. 2 is a block diagram of an exemplary system in which embodiments of the present invention may be employed;

FIG. 3 is a flow diagram showing an exemplary method for creating and saving a search macro in accordance with an embodiment of the present invention;

FIG. 4 is a flow diagram showing an exemplary method for performing a search using a search macro and presenting search results in a search results user interface based on user interface operators of the search macro in accordance with an embodiment of the present invention;

FIG. 5 is an illustrative screen display showing an exemplary search user interface with search macro options in accordance with an embodiment of the present invention;

FIG. 6 is an illustrative screen display showing an exemplary macro creation user interface in accordance with an embodiment of the present invention;

FIG. 7 is an illustrative screen display showing an exemplary search user interface including a search macro in accordance with an embodiment of the present invention; and

FIG. 8 is an illustrative screen display showing an exemplary search results user interface in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention permit, among other things, users to create search macros that are capable of modifying a search engine to perform searches and present results according to user specifications. When entering a search query, a user may select a particular search macro. A search is performed in accordance with operators defined by the selected search macro. Additionally, a search results user interface is generated based on user interface operators defined by the selected search macro. As such, embodiments of the present invention provide a simple and convenient way for users to effectively create their own search verticals and control the way search results are presented.

Accordingly, in one aspect, an embodiment of the invention is directed to a method for performing a search using a user-defined search macro and generating a search results user interface in accordance with the search macro. The method includes receiving a selection of the search macro from a user. The search macro has one or more user-defined search operators and one or more user-defined user interface operators. The method also includes receiving a search input from the user. The method further includes modifying a search engine in accordance with at least one of the search operators and the user interface operators and performing a search based on the search input using the modified search engine. The method further includes receiving one or more search results from the search and generating a search results user interface based on the search results and at least one of the user interface operators. The method still further includes communicating the search results user interface to the user.

In another aspect of the invention, an embodiment is directed to a system for processing search queries and generating search results user interfaces using user-defined search macros. The system includes a search engine that is modifiable by one or more search macros. The search engine is also operative to process a search query from a user after being modified by at least one of the search macros and to generate a search results user interface based on the search macro. The system also includes a search macro store having one or more user-defined search macros. Each of the search macros comprises a definition for modifying the search engine. Each definition includes one or more user interface operators specifying the presentation of search results in a search results user interface. The system further includes an interface component operative to receive the user search query and to receive a user selection of the at least one of the one or more search macros.

In yet another aspect, an embodiment of the invention is directed to one or more computer-readable media having stored thereon a data structure for a user-defined search macro. The data structure includes at least one first data field containing data representative of a user-defined search operator, wherein during a search operation, the user-defined search operator is used to modify search rules of a search engine. The data structure also includes at least one second data field containing data representative of a user-defined user interface operator, wherein during the search operation, the user-defined user interface operator is used to modify user interface generation rules of the search engine.

Having briefly described an overview of the present invention, an exemplary operating environment for the present invention is described below.

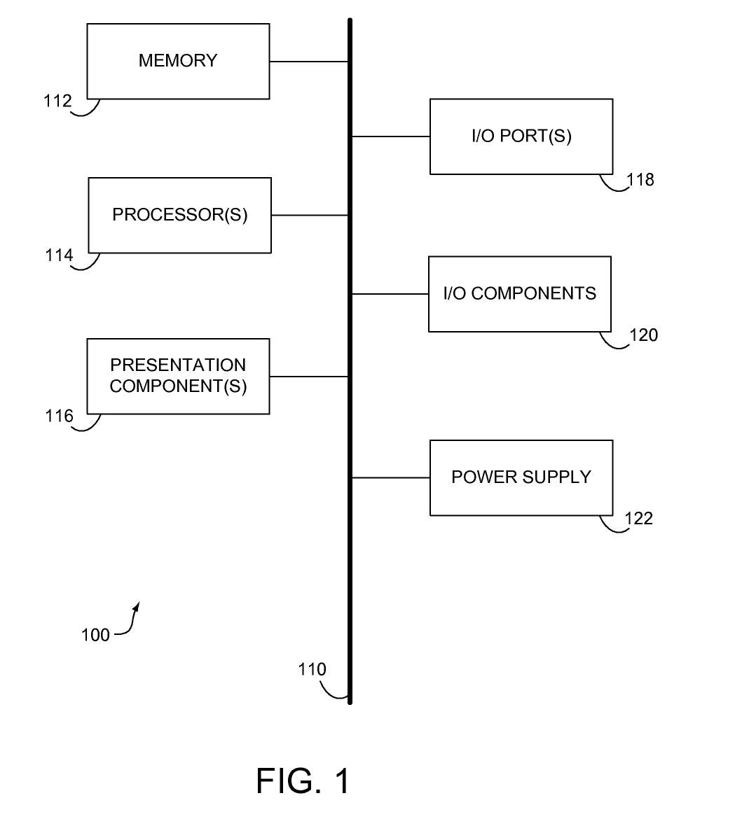

Referring initially to FIG. 1 in particular, an exemplary operating environment for implementing the present invention is shown and designated generally as computing device 100. computing device 100 is but one example of a suitable computing environment and is not intended to suggest any limitation as to the scope of use or functionality of the invention. Neither should the computing-environment 100 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. We recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. By way of example, and not limitation, computer-readable media may comprises Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, carrier wave or any other medium that can be used to encode desired information and be accessed by computing device 100.

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

As previously mentioned, embodiments of the invention relate to providing a simple approach for users to create search verticals. Instead of having to build a search vertical from top to bottom, a user may simply create a “search macro” that defines aspects of a personalized search vertical. A search macro is an advanced search modifier comprising a custom, user-created group of search operators and user interface operators. Search operators control aspects regarding how a search is performed. For instance, search operators may be used to restrict searches and results to particular websites and/or particular types of content (e.g., image content or real-time news content). User interface operators control aspects regarding how search results are presented in a search results user interface. A search macro may be created by a user and stored on a search engine server such that the search macro is accessible to other users. A template approach may be provided for macro creation in which search engine features (e.g., search operators and user interface operators) are modularized and exposed to allow users to define those features. In operation, a search macro modifies various rules of a pre-defined search engine in accordance with the user-defined group of search operators and user interface operators, thereby controlling how the search is performed and how the search results are presented.

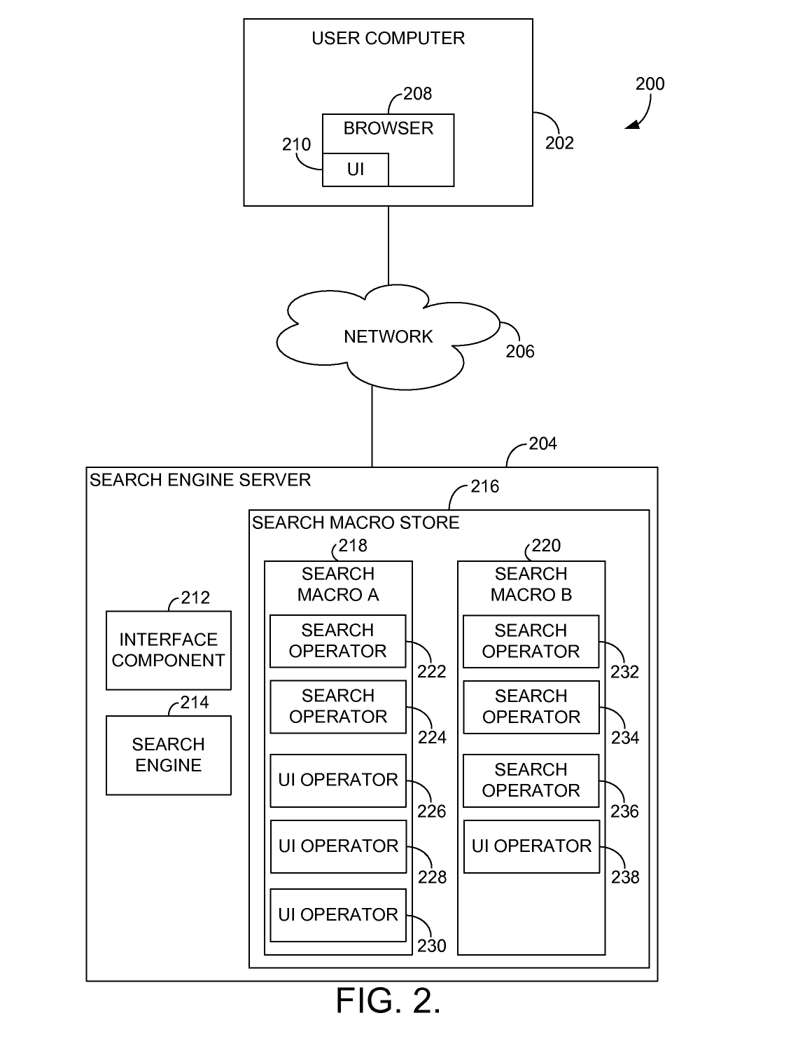

Referring now to FIG. 2, a block diagram is provided illustrating an exemplary system 200 in which embodiments of the present invention may be employed. Among other components not shown, the system 200 may include a user computer 202 and a search engine server 204. Each of the user computer 202 and search engine server 204 may be any type of computing device, such as computing device 100 described with reference to FIG. 1, for example. The user computer 202 and search engine server 204 may communicate with each other via a network 206, which may include, without limitation, one or more local area networks (LANs) and/or wide area networks (WANs). Such networking environments are commonplace in offices, enterprise-wide computer networks, intranets, and the Internet. It should be understood that any number of user computers, search engines, and networks may be employed within system 200 within the scope of the present invention. Additionally, other components not shown may also be included within the system 200. Further, additional components not shown may also be included within each of the user computer 202 and the search engine server 204.

The user computer 202 includes a browser 208 accessible through a user interface (UI) 210. The browser 208 may be employed to communicate with the search engine server 204 via the network 206. Additionally, the search engine server 204 includes an interface component 212 for communicating with the user computer 202 via the network 206. The search engine server 206 further includes a search engine 214 and a search macro store 216. The search engine 214 is configured to access data from one or more computing devices and generate search results based on a user's search input. Those skilled in the art will recognize that various search utilities exist in the art and that embodiments of the present invention may utilize any number of those known search techniques.

The search engine is further configured to be modifiable by one or more search macros maintained by the search macro store 216. The search macro store 216 may maintain any number of user-created search macros, such as search macro A 218 and search macro B 220. Each search macro may contain any number of operators for modifying the search engine 214 for a particular search. These operators may include search operators, which modify the search rules of the search engine 214, and user interface operators, which modify user interface generation rules of the search engine 214. For example, the search macro A 218 contains search operators 222 and 224, as well as user interface operators 226-228. The search macro B 220 includes search operators 232-236 and user interface operator 238. In various embodiments of the invention, search macros stored by the search macro store 216 are accessible to any user.

In operation, a user may employ the browser 208 on the user computer 202 to access the search engine server 204. The user may create a new search macro for storage in the search macro store 216. In some embodiments, the user may also be able to modify an existing search macro. The user may further be able to perform searches using one or more of the stored search macros. When performing such a search, the user may select a particular search macro, such as search macro A 218, and may enter a search input. In response to the user actions, the search engine server 204 modifies the search engine 214 based on the operators defined by the selected search macro. The modified search engine 214 then carries out a search based on the search input and generates a search results user interface in accordance with user interface operators defined by the selected search macro. The search results user interface may then be communicated to the user computer 202 for presentation via the browser 208.

In accordance with various embodiments of the present invention, aspects of the search results user interface that a search vertical may be given specific control over via user interface operators of a search macro may include one or more of the following (which are described in further detail below):
Cosmetic
Answers/Federations
Composite Pages
Widgets
Search Columns
Sorts
Search Refinement Controls
Results Descriptions
Extensible Markup Language (XML) Transform
   Cosmetic

Initially, in accordance with embodiments of the invention, a search vertical may be given control over cosmetic aspects of the search results user interface. The cosmetic aspects may include any type of aesthetic feature of the search results user interface, such as, for instance, font types, font sizes, colors, styles, and logos presented on the user interface.

For instance, a user may wish to control the cosmetic aspects of the search user interface such that the user interface mimics the look of a particular website. For example, a user creating a Wired Magazine search vertical may wish to create a search user interface that appears similar to wired.com. Accordingly, employing embodiments of the present invention, the user may include the Wired banner in the search user interface. Additionally, the user may set the fonts and colors to match those of wired.com.

As another example, a user may wish to create a search vertical directed to portable device users. Accordingly, the user may wish to user larger fonts in the search user interface to compensate for portable devices' limited screen sizes.

Answers/Federations

Search verticals sometimes provide search answers with search results. For example, answers determined to be highly relevant to a search request may be shown at the top of the results set. As a specific example, a user may enter a search that includes “what is the population of China.” A search vertical may be designed to provide a specific fact-based answer to the search that includes the exact population in addition to typical search results. The answer could be provided anywhere within the user interface, but typically is provided at the top of the results set.

In accordance with some embodiments of the present invention, users may specify specific types of answers to be shown with search results. Additionally, users may specify federations to other data provides, such as via RSS (e.g., Really Simple Syndication, Rich Site Summary, RDF Site Summary, Real-time Simple Syndication) or other techniques. For example, a user may create a search macro and specify news headlines as an answer type. Based on the user specification, news results would be shown as answers. As another example, a search macro could be created such that results from a particular blog, such as Robert Scoble's blog, are displayed as answers.

In addition to specifying the type of answers to be provided, the user may specify where the answers are provided in relation to other search results. As such, in accordance with embodiments of the invention, the user is given control over the types of answers to be shown, as well as the location at which answers are presented relative to other search results.

Composite Pages

In some cases, a user may create a search macro with operators for combining results from multiple search verticals. In such embodiments, a user may specify how the results are combined and presented in the search results user interface. In other words, when a search vertical is created that combines results from different searches, the user may specify how the results are interweaved together to provide a meaningful search results user interface. For example, a user could specify that the results user interface should present 10 web search results, followed by 30 image search results, followed by 10 health search results, etc.

Widgets

Generally, widgets are graphical user interface components or elements with which a user may interact, such as, for example, buttons, menu bars, and slider bars. In the context of search results user interface, widgets may include user interface components allowing users to interact with search results. In embodiments of the invention, a user may specify the number and types of widgets included in a search results user interface. In some embodiments, users may select from a group of pre-built widgets. Alternatively or additionally, users may build widgets by defining the look and functionality of the user interface elements.

Search Result Columns

When search verticals search over structured data, the results may be presented in a structured format. Typically, the results may be presented in a table format with common pieces of information from the various search results presented in specific columns. For example, in shopping search verticals, common data elements placed in columns may include data associated with product name, retailer name, price, etc. Embodiments of the present invention allows users to specify aspects of such search result columns, such as for example, which columns to present, column order, column widths, and other formatting aspects.

Sort Orders

Embodiments of the present invention further allow users to specify the sort order of results from a search. For example, in the context of structured data, the user may specify that the sort order of search results is dictated by a specific data piece. Accordingly, for a shopping vertical, the search vertical may be created such that search results are ordered by price, reviews, or another common aspect of the search results.

Search Refinement Controls

In embodiments, a search vertical may be defined such that the search results user interface includes a set of controls to allow users to refine their search queries. In some cases, the search refinement controls may be suggestions links (e.g., “show product reviews,” “show places I can buy the product”). Another type of search refinement control that may be incorporated into search results user interface is an alternative spelling suggestion. For instance, alternative spelling suggestions may be provided if it is determined that a keyword in the search input has been misspelled or an alternative spelling may be appropriate for the search. The search refinement controls may further include controls to sort or filter over structured data. For example, a real estate search vertical may be built such that the search result user interface includes a “price range” dropdown that allows users to specify the price range in which they're interested.

Result Descriptions

A further aspect of a search result user interface that a search vertical may be given control over is the creation and format of result descriptions. In particular, there are a variety of different ways in which results descriptions may be created to display to a user what was relevant for each search result. For example, a user may specify aspects such as whether the results description comprises excerpts corresponding with each result, whether an excerpt includes keyword highlighting, whether images are included, whether page previews are provided, and the length of the description. Some embodiments of the invention allow for different types of native display formats, such as showing images from results, providing shorter or longer descriptions, and showing page previews.

XML Transform

In some embodiments, a user may provide an XML transform (e.g., using extensible stylesheet language transformation—XSLT) as a user interface operator of a search macro. The XML transform may be configured to take an XML feed of search results and present the results based on user-defined parameters. In such embodiments, the user would be given radical control over how search results are displayed.

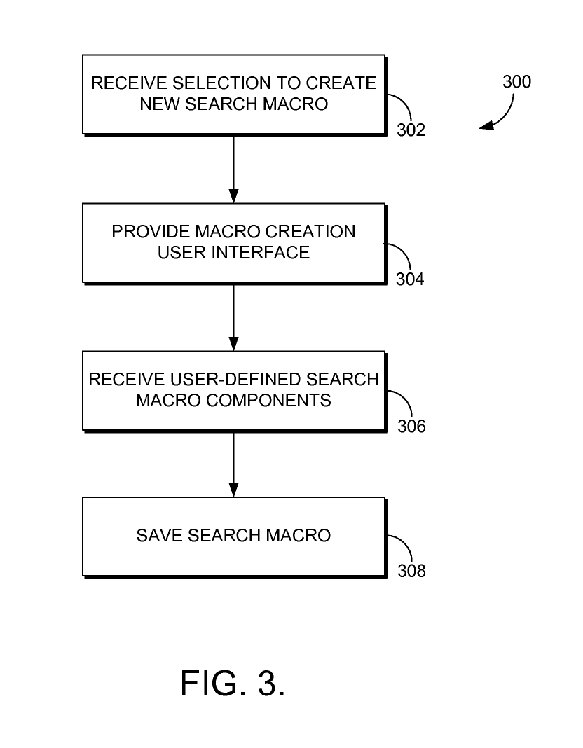

Turning to FIG. 3, a flow diagram is illustrated that shows an exemplary method 300 for creating and saving a search macro in accordance with an embodiment of the present invention. Initially, as shown at block 302, a user accesses a search engine server, such as the search engine server 204 of FIG. 2, and selects to create a new search macro. Typically, a user may access the search engine server by employing a web browser on the user's computer. In response to the user selection, the search engine server provides a macro creation user interface, as shown at block 304. By employing the macro creation user interface, the user may create a new search macro, as shown at block 306. The macro creation user interface may allow the user to specify a number of components of the new search macro, including, for example, a name, a default scope, a description of the search macro, and a definition. The definition is where the user specifies the search operators and user interface operators for the search macro. After creating the search macro, the user selects to save the search macro to the search engine server, as shown at block 308. Because the search macro is saved to the search engine server, it may be accessed by any user wishing to perform a vertical search.

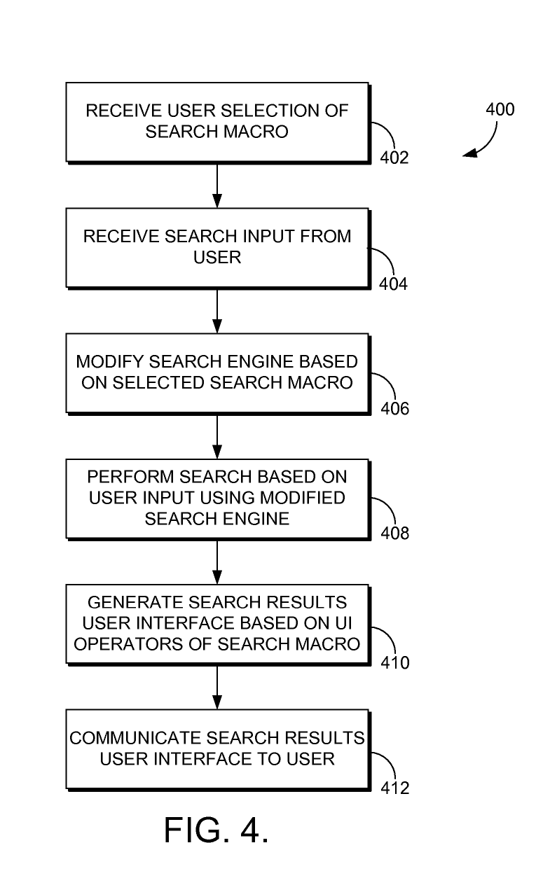

Referring now to FIG. 4, a flow diagram is illustrated that shows an exemplary method 400 for performing a vertical search using a search macro and presenting search results in a search results user interface based on user interface operators of the search macro in accordance with an embodiment of the present invention. The process may begin at block 402 when a user accesses a search engine server, such as the search engine server 204 of FIG. 2, and selects a search macro for performing a search. After selecting the appropriate search macro, the user enters a search input, as shown at block 404. In response to the search macro selection and entered search input, the search engine server modifies its search engine in accordance with the search operators and user interface operators defined by the selected search macro, as shown at block 406. The search engine server then performs a search based on the search input using the modified search engine, as shown at block 408. Results are retrieved by the modified search engine and a search results user interface is generated based on the retrieved results and the user interface operators defined by the selected search macro, as shown at block 410. The search results user interface is then communicated to the user's computer and presented in the user's browser, as shown at block 412.

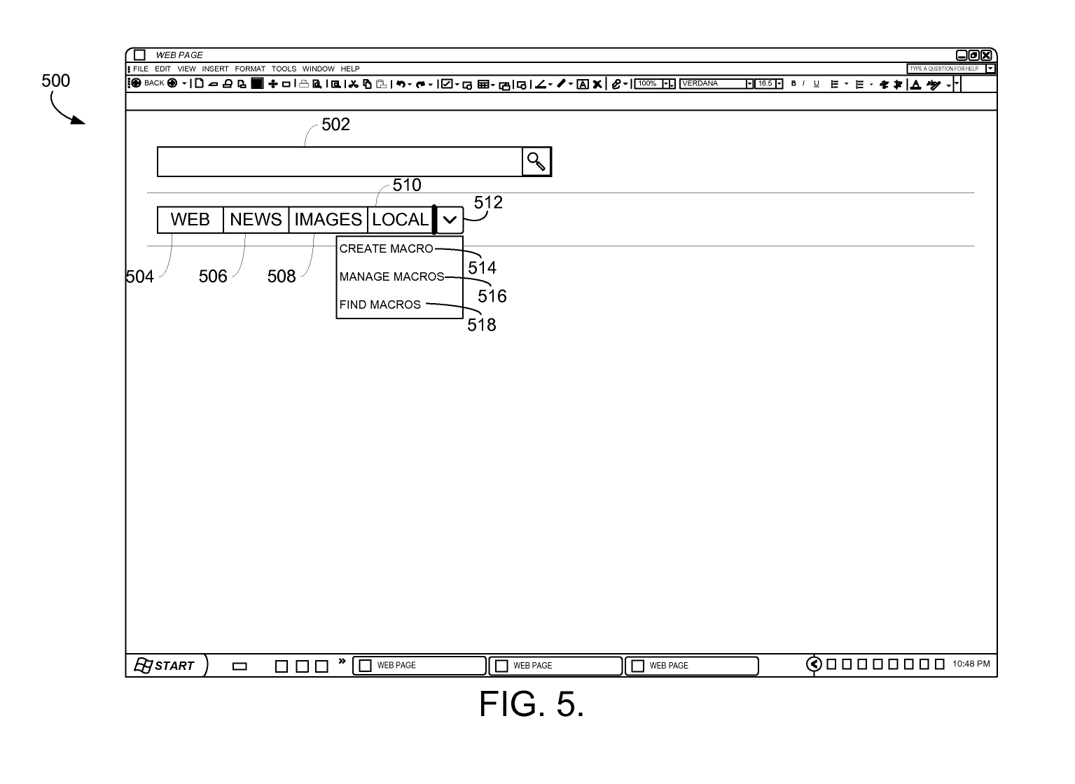

Referring now to FIG. 5 through FIG. 8, exemplary screen displays are provided illustrating the creation and use of a search macro in accordance with an embodiment of the present invention. It will be understood and appreciated by those of ordinary skill in the art that the screen displays of FIG. 5 through FIG. 8 are provided by way of example only and are not intended to limit the scope of the present invention in any way. Referring initially to FIG. 5, an exemplary screen display 500 of a search user interface is shown. A user may have accessed the search user interface, for example, by using a web browser on the user's computer to access a search engine server, such as the search engine server 204 of FIG. 2. The search user interface generally includes a search input area 502 and several tabs for commercially-available search engines, including a general web search 504, a news search vertical 506, an images search vertical 508, and a local search vertical 510. The search user interface further includes a dropdown menu 512 with search macro related options, including options to create a macro 514, manage macros 516, and find macros 518.

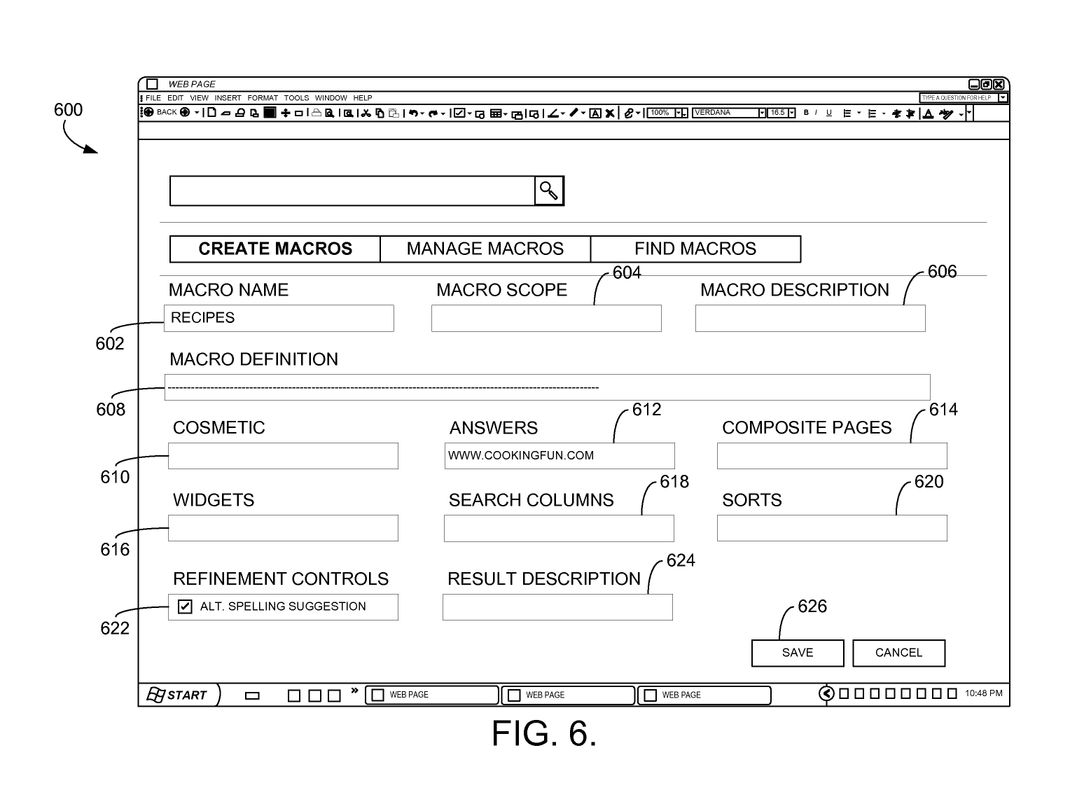

In the present example, the user selects the create macro option 514 to navigate to a macro creation user interface, such as that shown in the screen display 600 of FIG. 6. The macro creation user interface generally includes an area for a user to name the new macro 602, an area to specify the scope of the macro 604, and an area to provide a macro description 606. The macro creation user interface also includes a macro definition area 608 for a user to specify search operators for the search macro. The macro creation user interface further includes areas for specifying user interface operators (i.e., features of the search results user interface), including an area to specify cosmetic features 610, answers 612, composite page features 614, widgets 616, search columns 618, sorts 620, refinement controls 622, and result descriptions 624. As shown in FIG. 6, the user has named the search macro “RECIPES.” The user also has entered a number of search operators in the macro definition area 608 (e.g., limiting the search to results that include recipes). Additionally, the user has defined a couple of user interface operators. In particular, the user has indicated in the answers area 612 that results from “www.cookingfun.com” should be provided as answers. Further, the user has indicated at the refinement controls area 622 that alternative spelling suggestions should be provided in the search results user interface. After the user has completed making selections, the user may select the “save” button 626 to save the new search macro. It should be noted that macro creation user interfaces within various embodiments of the invention may employ any combination of user interface elements for collecting user specifications, including dropdown menus, pick lists, and free text boxes. In one embodiment, a “wizard” may be provided for walking a user through the process of creating a search macro.

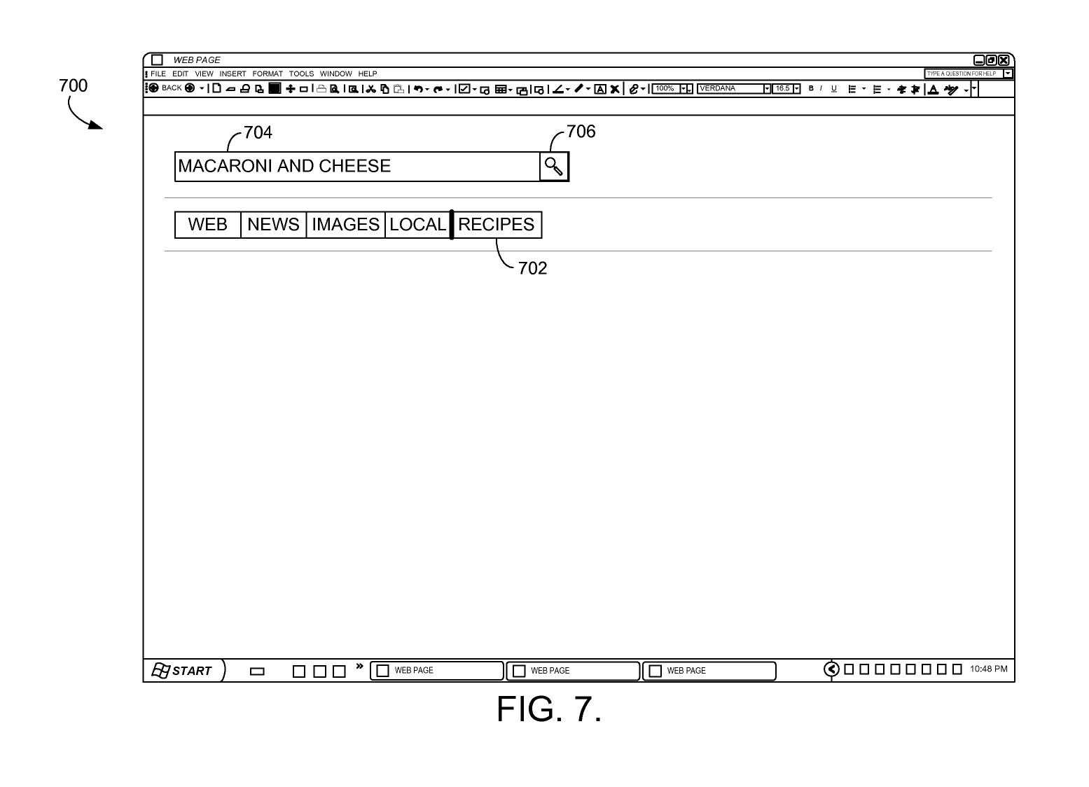

After a new search macro has been created (or an existing search macro has been selected as a possible search option), the search macro may be shown as a possible selection for performing searches. For example, in the screen display 700 of FIG. 7, a search user interface is shown in which the “RECIPES” search macro 702 is provided. The user may select the search macro 702 and enter a search input, such as “MACARONI AND CHEESE” in the search input area 704. The user may then select the search button 706 and a search may be performed in accordance with the selected search macro.

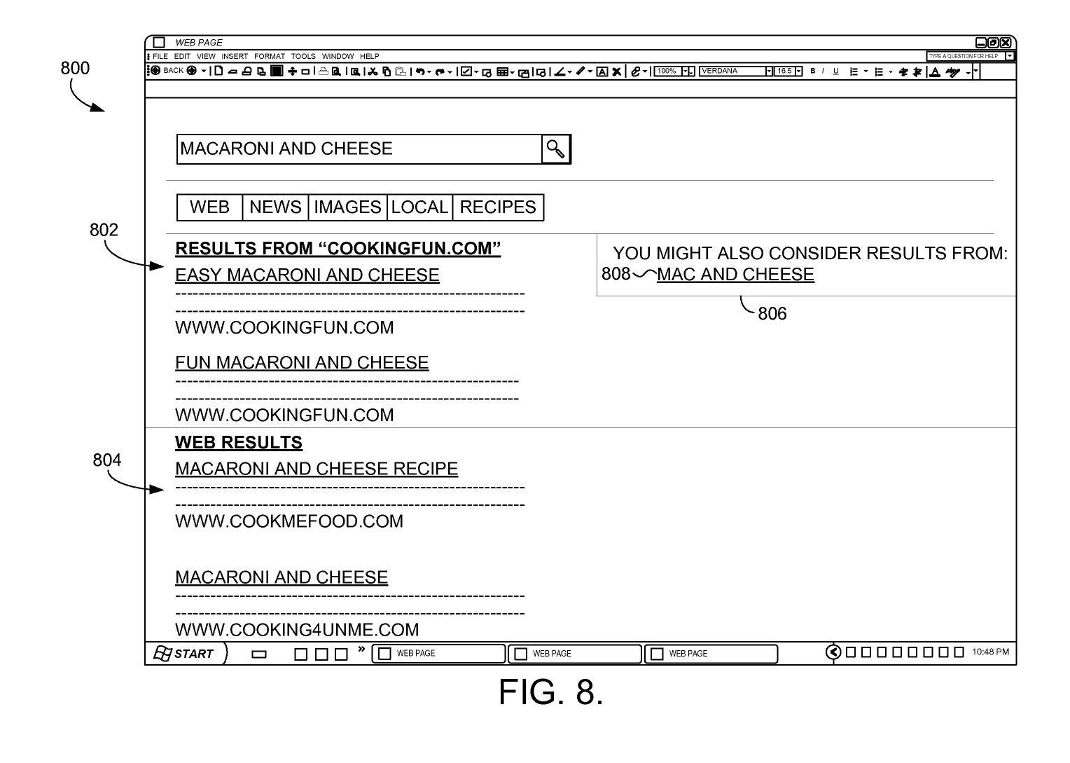

An exemplary search results user interface is shown in the screen display 800 of FIG. 8. As shown in FIG. 8, the search results user interface includes an answer area 802 that includes results from “www.cookingfun.com” in accordance with the user interface operator for answers that was specified in the “RECIPES” search macro. The answer area 802 is presented above other web results 804. Additionally, a suggestion area 806 is provided with a spelling suggestion link 808 in accordance with the user interface operator for search refinement controls that was specified in the “RECIPES” search macro.

As can be understood, embodiments of the present invention provide a simplified and convenient approach to allowing users to create search verticals having control over elements of the search results user interface. The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. A method for performing a search using a user-defined search macro and generating a search results user interface in accordance with the search macro, the method comprising:
receiving a selection of the search macro from a user, the search macro having one or more user-defined search operators and one or more user-defined user interface operators;
receiving a search input from the user;
modifying a search engine in accordance with at least one of the one or more search operators and the one or more user interface operators;
performing a search based on the search input using the modified search engine;
receiving one or more search results from the search;
generating a search results user interface based on the one or more search results and at least one of the one or more user interface operators; and
communicating the search results user interface to the user.

2. The method of claim 1, further comprising:
receiving a user selection to create a search macro;
providing a macro creation user interface;
receiving user-defined search macro components for the search macro; and
saving the search macro in a search macro store.

3. The method of claim 1, wherein at least one of the one or more user interface operators controls one or more cosmetic features of the search results user interface.

4. The method of claim 1, wherein at least one of the one or more user interface operators specifies one or more answers to be provided with the one or more search results in the search results user interface.

5. The method of claim 1, wherein at least one of the one or more user interface operators specifies the combination of search results from multiple types of search verticals.

6. The method of claim 1, wherein at least one of the one or more user interface operators specifies one or more widgets for presentation in the search results user interface.

7. The method of claim 1, wherein at least one of the one or more user interface operators specifies one or more search columns for presentation in the search results user interface.

8. The method of claim 1, wherein at least one of the one or more user interface operators specifies a sort order for the one or more search results in the search results user interface.

9. The method of claim 1, wherein at least one of the one or more user interface operators specifies one or more search refinement controls for the search results user interface.

10. The method of claim 1, wherein at least one of the one or more user interface operators specifies a result description for one or more search results in the search results user interface.

11. The method of claim 1, wherein at least one of the one or more user interface operators comprises an XML transform.

12. One or more computer-readable media having computer-useable instructions embodied thereon for performing the method of claim 1.

13. A system for processing search queries and generating search results user interfaces using user-defined search macros, the system comprising:
a search engine modifiable by one or more search macros, the search engine operative to process a search query from a user after being modified by at least one of the one or more search macros and to generate a search results user interface based on the at least one of the one or more search macros; and
a search macro store having one or more user-defined search macros, each of the one or more search macros comprising a definition for modifying the search engine, each definition including one or more user interface operators specifying the presentation of search results in a search results user interface; and
an interface component operative to receive the user search query and to receive a user selection of the at least one of the one or more search macros.

14. The system of claim 13, wherein the interface component is further operative to receive a request to create a search macro, provide a macro creation user interface to the user, receive user-defined search macro components, and save the search macro to the search macro store.

15. The system of claim 13, wherein the interface component is further operative to receive a request to modify a search macro, provide a macro editing user interface to the user, receive user changes to the search macro, and save the user changes to the search macro to the search macro store.

16. The system of claim 13, wherein the one or more user interface operators define one or more user interface features.

17. The system of claim 16, wherein the one or more user interface features include at least one of a cosmetic feature, an answer feature, a composite page feature, a widget feature, a search column feature, a sort feature, a search refinement control feature, and a result description feature.

18. One or more computer-readable media having stored thereon a data structure for a user-defined search macro, the data structure comprising:
at least one first data field containing data representative of a user-defined search operator, wherein during a search operation, the user-defined search operator is used to modify search rules of a search engine; and
at least one second data field containing data representative of a user-defined user interface operator, wherein during the search operation, the user-defined user interface operator is used to modify user interface generation rules of the search engine.

19. The one or more computer-readable media of claim 18, wherein the user-defined user interface operator defines one or more user interface features.

20. The one or more computer-readable media of claim 19, wherein the one or more user interface features includes at least one of a cosmetic feature, an answer feature, a composite page feature, a widget feature, a search column feature, a sort feature, a search refinement control feature, and a result description feature.
